(19) United States
(12) Patent Application Publication
(10) Pub. No.: US 2008/0176641 A1
(43) Pub. Date: Jul. 24, 2008

(54) GAME SYSTEM AND PLAYING METHOD ACCEPTING BETS IN MIDDLE OF GAME

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/935,786

(22) Filed: Nov. 6, 2007

Related U.S. Application Data
(60) Provisional application No. 60/881,495, filed on Jan. 22, 2007.

(51) Int. Cl. A63F 13/00

(52) U.S. Cl. 463/25

(57) ABSTRACT

A game system of the present invention includes a plurality of client terminals, each of which having a BET switch for inputting a BET, and a controller programmed so as to execute the following processing of: (a) accepting an input of a normal BET from each of the BET switches provided in any of the plurality of client terminals during a first predetermined period; (b) accepting an input of a middle-of-game BET, which is different from the normal BET inputted within the first predetermined period, from the respective BET switches in any of the plurality of client terminals, at which no normal BET has been inputted, during a second predetermined period after passage of the first predetermined period; (c) executing a game to determine a result; (d) offering a prize corresponding to the game result and the inputted normal BET, to any of the plurality of client terminals at which the normal BET has been inputted; and (e) offering a prize corresponding to the game result and/or the game result on the client terminal at which the normal BET has been inputted and the inputted middle-of-game BET, to any of the plurality of client terminals at which the middle-of-game BET has been inputted.

### CROSS-REFERENCE TO RELATED APPLICATIONS

This application claims benefit of priority based on U.S. Provisional Patent Application No. 60/881,495 filed on Jan. 22, 2007. The contents of this application are incorporated herein by reference in their entirety.

### BACKGROUND OF THE INVENTION

1. Field of the Invention

The present invention relates to a game system where a BET can be inputted and a method for playing a game by betting.

2. Discussion of the Background

There conventionally exist game systems which include a plurality of client terminals and execute a game in common among a plurality of players. Among such game systems, there are game systems that include a plurality of client terminals and a common screen, and execute a slot machine game or a roulette game displayed to the common screen, as disclosed in US 2005/0059474-Al, US 2005/0282618-Al, and US 2005/0218590-Al. In such a game, a player playing the game at each client terminal can place a BET on a result of the game displayed to the common screen. For example, when a slot machine game is displayed to the common screen, a BET can be placed on a line number, and when a roulette game is displayed, a straight BET or a combination BET can be placed on a layout of the roulette.

It is an object of the present invention to provide a game system capable of reducing the waiting time in participating a multiplayer-entry-type game, and having a new entertainment property.

The contents of US 2005/0059474-Al, US 2005/0282618-Al, and US 2005/0218590-Al are incorporated herein by reference in their entirety.

### SUMMARY OF THE INVENTION

A first aspect of the present invention provides a game system having the following configuration.

Namely, the game system includes a plurality of client terminals, each of which having a BET switch for inputting a BET. Further, the game system includes a controller programmed so as to execute the following processing of: (a) accepting an input of a normal BET from each of the BET switches provided in the plurality of client terminals during a first predetermined period; (b) accepting an input of a middle-of-game BET, which is different from the normal BET inputted within the first predetermined period, from the respective BET switches in any of the plurality of client terminal, at which no normal BET has been inputted, during a second predetermined period after passage of the first predetermined period; (c) executing a game to determine a result; (d) offering a prize corresponding to the game result and the inputted normal BET, to any of the client terminals at which the normal BET has been inputted; and (e) offering a prize corresponding to the game result and/or the game result in any of the client terminals at which the normal BET has been inputted and the inputted middle-of-game BET, to any of the plurality of the client terminals at which the middle-of-game BET has been inputted.

A second aspect of the present invention provides a game system having the following configuration.

Namely, the game system includes a plurality of client terminals, each of which having a BET switch for inputting a BET. Further, the game system includes a controller programmed so as to execute the following processing of: (a) accepting an input of a normal BET from each of the BET switches provided in the plurality of client terminals during a first predetermined period; (b) accepting an input of an additional BET subject to any of the plurality of client terminals at which the normal BET has been inputted within the first predetermined period, from the respective BET switches in any of the plurality of client terminals at which no normal BET has been inputted, during a second predetermined period after passage of the first predetermined period; (c) executing a game to determine a result; (d) offering a prize corresponding to the game result with respect to the normal BET and the inputted normal BET, to any of the plurality of client terminals at which the normal BET has been inputted; and (e) offering a prize corresponding to the game result in any of the plurality of client terminals at which the normal BET has been inputted and the inputted additional BET, to any of the plurality of client terminals at which the additional BET has been inputted.

A third aspect of the present invention provides a game system having the following configuration.

Namely, the game system includes a plurality of client terminals, each of which having a BET switch for inputting a BET. Further, the game system includes a display viewable by a player who executes the game at each of the plurality of client terminals. Moreover, the game system includes a controller programmed so as to execute the following processing of: (a) executing a game to display a result to the display; (b) accepting an input of a normal BET from each of the BET switches provided in the plurality of client terminals during a first predetermined period until the game result is displayed to the display; (c) accepting an input of an additional BET subject to any of the plurality of client terminals at which the normal BET has been inputted within the first predetermined period, from the respective BET switches of the plurality of client terminals at which no normal BET has been inputted, during a second predetermined period until the game result is displayed to the display after passage of the first predetermined period; (d) offering a prize corresponding to the game result with respect to the normal BET and the inputted normal BET, to any of the plurality of client terminals at which the normal BET has been inputted; and (e) offering a prize corresponding to the game result in any of the plurality client terminals at which the normal BET has been inputted and the inputted additional BET, to any of the plurality of client terminals at which the additional BET has been inputted.

A fourth aspect of the present invention includes a game system with the following configuration.

Namely, the game system includes a plurality of client terminals, each of which having a BET switch for inputting a BET. Further, the game system includes a controller programmed so as to execute the following processing of: (a) accepting an input of a normal BET from each of the BET switches provided in the plurality of client terminals during a first predetermined period; (b) accepting an input of a middle-of-game BET, which is different from the normal BET inputted within the first predetermined period, from the respective BET switches in any of the plurality of client terminals at which no normal BET has been inputted, during a second predetermined period of a game progress after passage of the first predetermined period; (c) executing a game to determine a result; (d) offering a prize corresponding to the game result and the inputted normal BET, to any of the plurality of client terminals at which the normal BET has been inputted; and (e) offering a prize corresponding to the game result and/or the game result in any of the plurality of client terminal at which the normal BET has been inputted and the inputted middle-of-game BET, to the client terminal at which the middle-of-game BET has been inputted.

The first aspect of the present invention provides a method for playing a game with the following processing.

Namely, the method for playing a game includes the steps of: (a) accepting a normal BET during a first predetermined period; (b) accepting a middle-of-game BET, which is different from the normal BET placed within the first predetermined period, from a player having placed no normal BET during a second predetermined period after passage of the first predetermined period; (c) executing a game to determine a result; (d) offering a prize corresponding to the game result and the normal BET, to a player having placed the normal BET; and (e) offering a prize corresponding to the game result and/or the game result of the player having placed the normal BET and the middle-of-game BET, to the player having placed the middle-of-game BET.

### BRIEF DESCRIPTION OF THE DRAWINGS

FIG. 1 is a flow chart showing a subroutine of control-device-side processing executed by the control device provided in a game system according to one embodiment of the present invention;

FIG. 2 is a perspective view schematically showing an external structure of the game system according to one embodiment of the present invention;

FIG. 3 is a view for illustrating winning lines;

FIG. 4 is a view showing one example of symbol arrays;

FIG. 5A is a view showing one example of an image displayed to a front display;

FIG. 5B is another view showing one example of an image displayed to the front display;

FIG. 5C is another view showing one example of an image displayed to the front display;

FIG. 6 is a perspective view schematically showing an external structure of a station;

FIG. 7A is a view showing one example of an image displayed to a liquid crystal display;

FIG. 7B is another view showing one example of an image displayed to the liquid crystal display;

FIG. 7C is another view showing one example of an image displayed to the liquid crystal display;

FIG. 8 is a block diagram showing an internal structure of the control device;

FIG. 9 is a block diagram showing an internal structure of a station;

FIG. 10 is a flowchart showing a subroutine of symbol determination processing;

FIG. 11 is a view showing a possibility for establishment of each symbol combination and the number of payouts;

FIG. 12 is a flowchart showing a subroutine of a station-side processing executed in a station; and

FIG. 13 is a flowchart showing a subroutine of payout processing.

### DESCRIPTION OF THE EMBODIMENTS

The first aspect of the present invention is an invention to accept a middle-of-game BET, which is different from a normal BET placed within a first predetermined period, during a second predetermined period after passage of the first predetermined period. The second aspect of the present invention is the first aspect of the present invention in which the above-mentioned middle-of-game BET is an additional BET subject to client terminals at which the normal BET has been inputted within the first predetermined period. The third aspect of the present invention is the second aspect of the present invention in which a game result is displayed to a display. The fourth aspect of the present invention is an invention to accept a middle-of-game BET, which is different from a normal BET placed within the first predetermined period, during the second predetermined period of a game which progresses after passage of the first predetermined period.

In the following descriptions, when the first aspect of the present invention, the second aspect of the present invention, the third aspect of the present invention and the fourth aspect of the present invention are not particularly distinguished from one another, each of those aspects is simply referred to as the present invention.

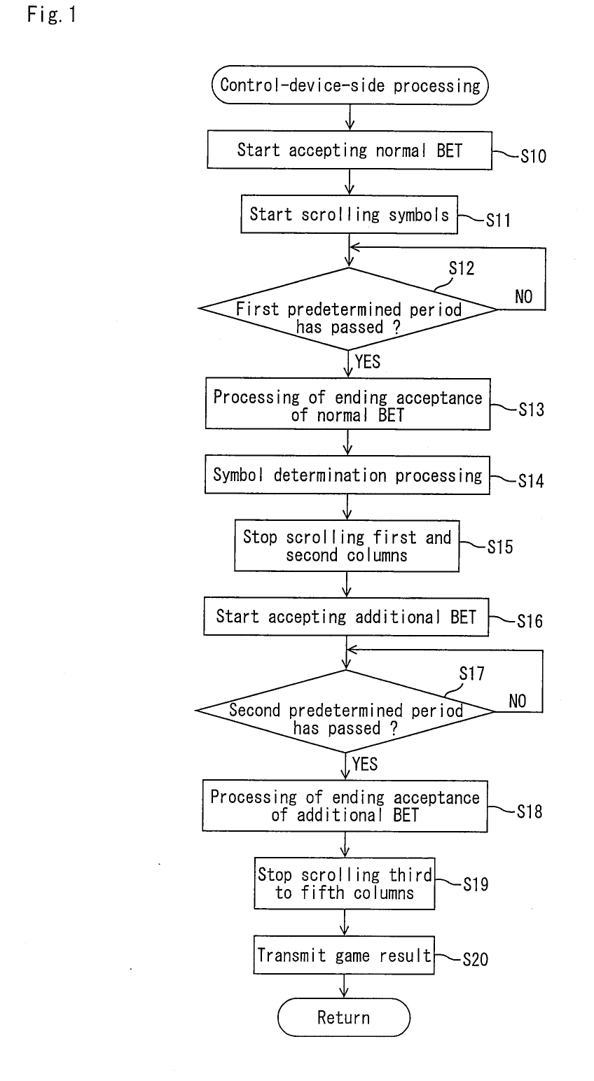

FIG. 1 is a view showing one example of control-device-side processing executed by the control device provided in a game system according to one embodiment of the present invention.

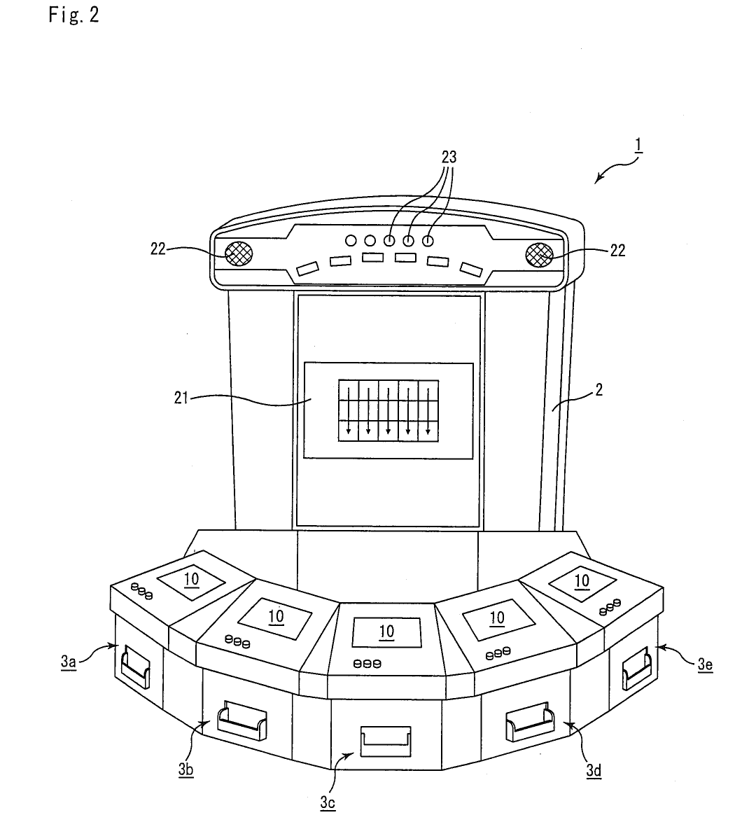

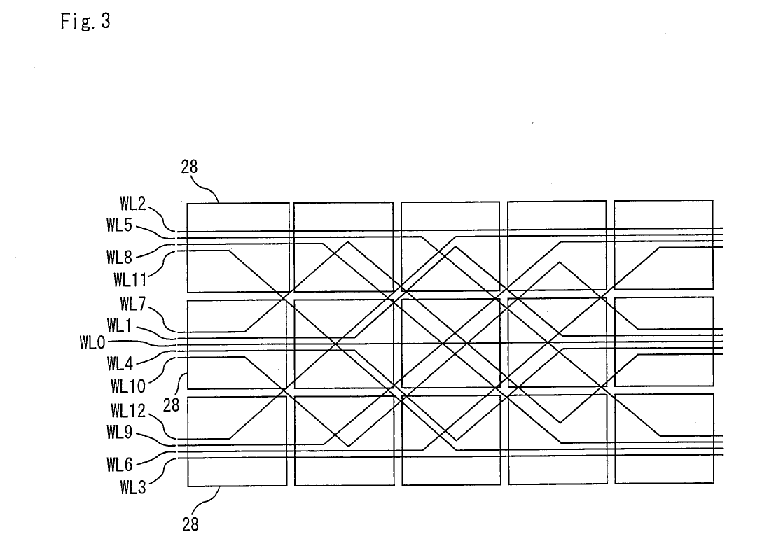

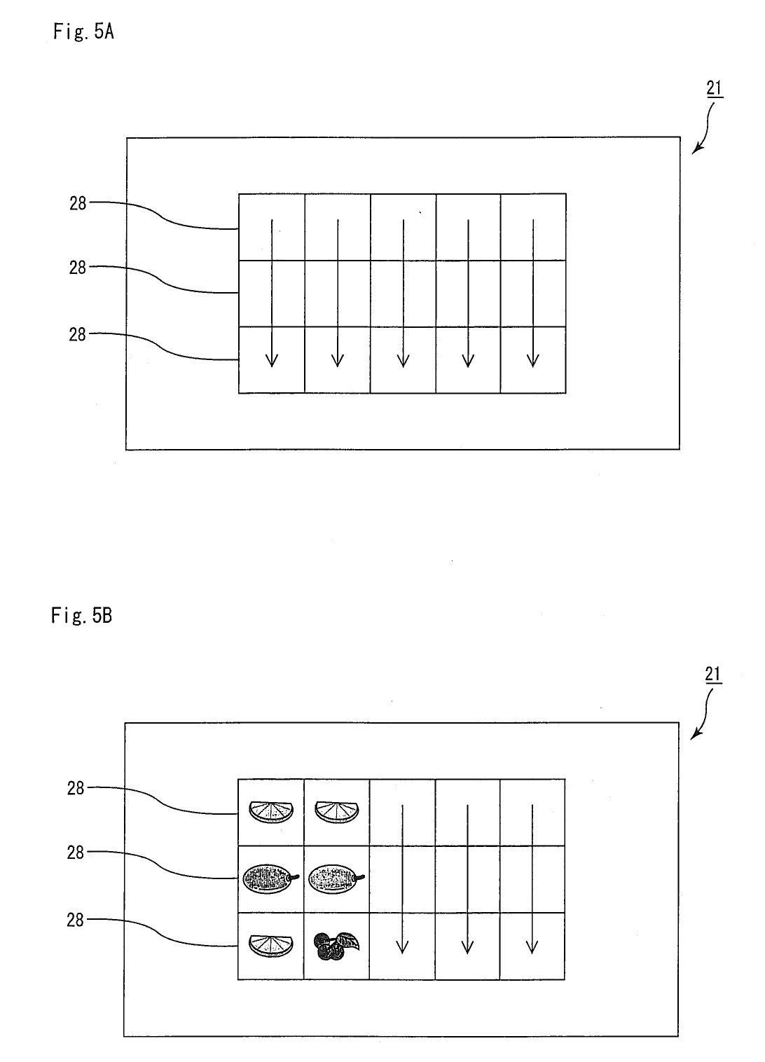

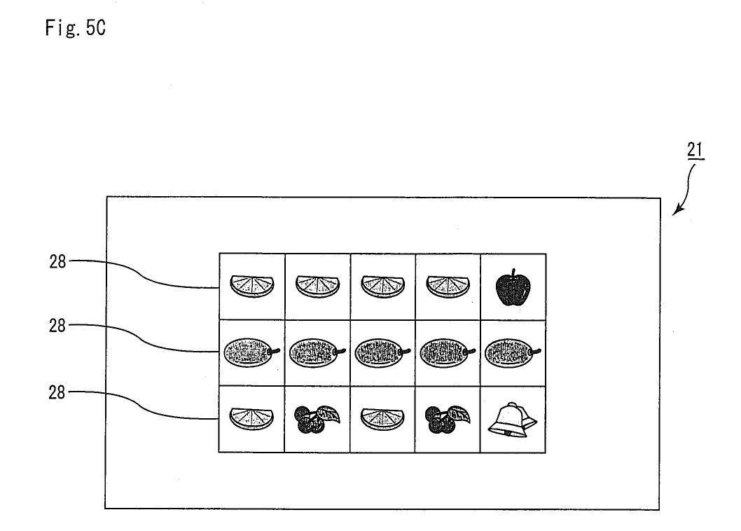

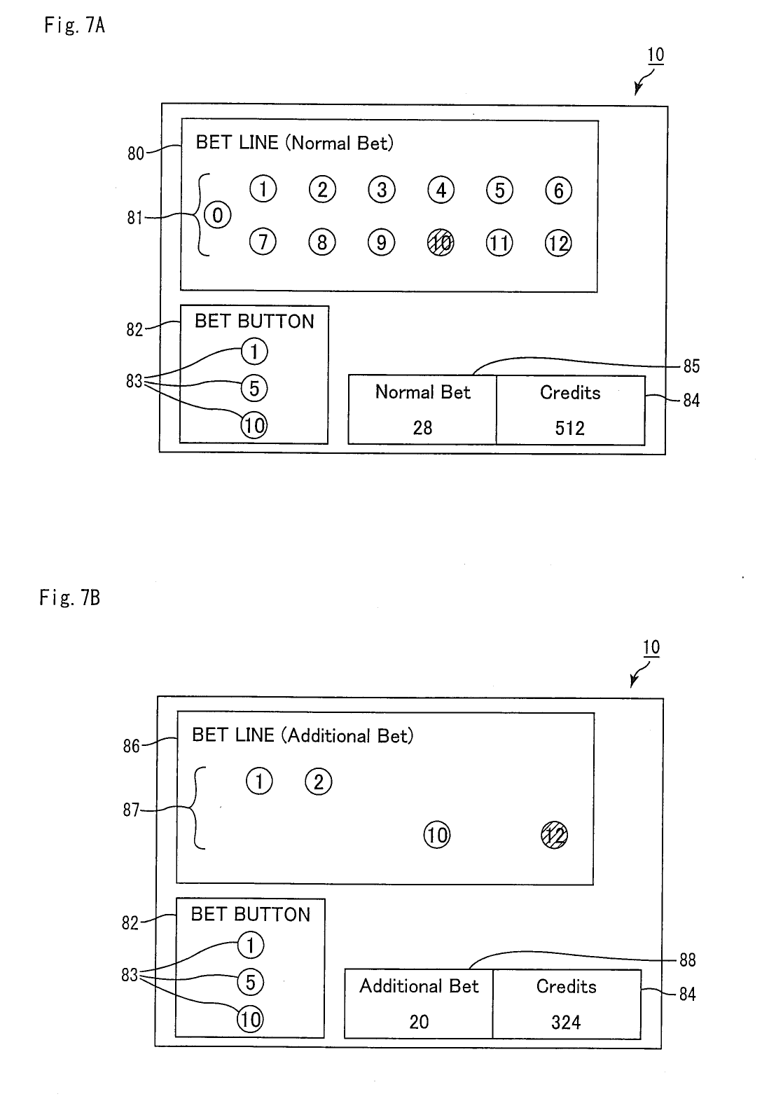

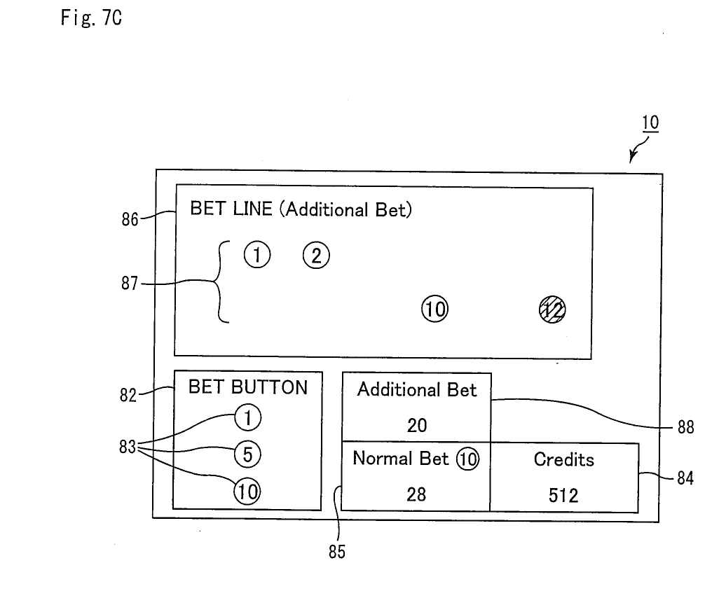

In a game system 1 (see FIG. 2), a slot machine game is executed. 15 display blocks 28 in five columns and three rows are displayed to a main monitor 2 included in the game system 1, and one symbol is arranged in each of the display blocks 28 (see FIGS. 5A to 5C). Further, 13 winning lines WL0 to WL12 passing across all the columns are set in the main monitor 2 (see FIG. 3). At each of stations 3 (see FIG. 2), a player can operate a BET line select button 81 (see FIG. 7A) to select a winning line on which a BET is to be placed, and can operate a number-of-BETs input button 83 (FIG. 7A) to input the number of BETs on the selected winning line WL. In the main monitor 2, when the symbols are stop-displayed after scrolling, when the same symbols are arranged on the winning line WL on which the BET has been placed (when any of the predetermined symbol combinations has been established), coins corresponding to the symbol combination and the number of BETs are paid out to the station 3 operated by the player.

The processing executed by a control device provided in the game system 1 according to one embodiment of the present invention is described in the following.

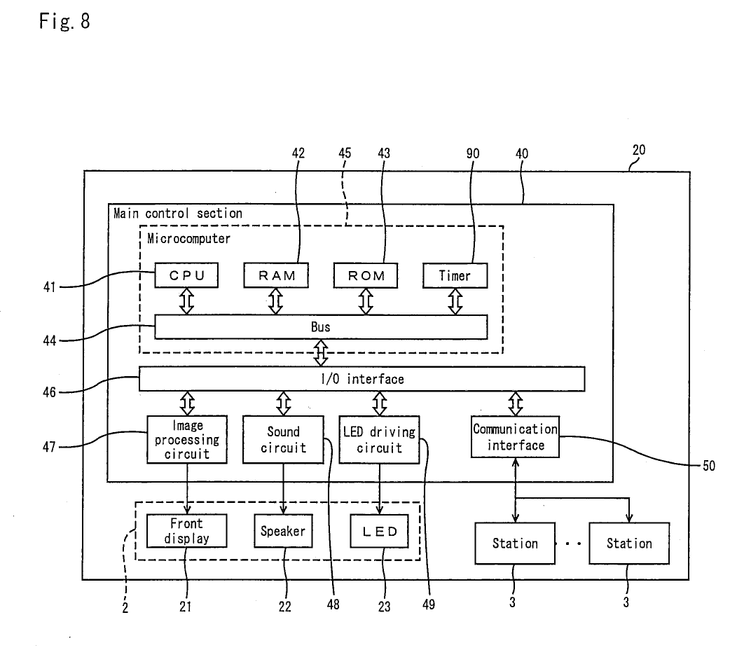

First, in step S10, a CPU 41 (see FIG. 8) of a control device 20 provided in the game system 1 starts accepting a normal BET. In this processing, the CPU 41 transmits a signal (hereinafter also referred to as normal BET start signal) for making each of the stations 3 start accepting an input of the normal BET. The normal BET can be inputted at each of the stations 3 where this signal has been received. At this time, the CPU 41 starts measuring time by means of a timer 90 for measuring a first predetermined period (e.g. thirty seconds). After the start of accepting the normal BET, when the CPU 41 receives normal BET information that the normal BET has been placed at the respective stations 3 and normal BET information showing contents of the normal BET, the received information is stored in a RAM 42.

Next, in step S1, the CPU 41 starts scrolling the symbols on the main monitor 2 (see FIG. 5A), and waits until the first predetermined period has passed (step S12).

When it is determined in step S12 that the first predetermined period has passed, the CPU 41 conducts processing for ending acceptance of the normal BET (step S13). In this processing, the CPU 41 transmits a signal (hereinafter also referred to as normal BET end signal) for making each of the stations 3 end accepting an input of the normal BET. Upon receipt of this signal, each of the stations 3 ends accepting an input of the normal BET.

Next, in step S14, the CPU 41 conducts symbol determination processing. In this symbol determination processing, the CPU 41 determines the symbols to be arranged in the respective display blocks 28 at a stoppage of the symbols.

Although a case is described in the present embodiment where the symbols to be arranged in the display blocks 28 as a game result are determined after the end of accepting the normal BET, timing for determining the game result is not limited to this example in the present invention. For example, the timing for determination may be before passage of the first predetermined period, before the start of accepting the normal BET, after the start of accepting a later-described additional BET or after the end of accepting the additional BET.

In the present invention, the “game result” means a result of a game which is common between a player having placed the normal BET and a player having placed the later-described additional BET (or middle-of-game BET), and is referred to at the time of offering a prize. The “game result” in the present embodiment is an arrangement state of symbols arranged in the display blocks 28.

Next, in step S15, the CPU 41 stops scrolling the symbols along a first column (left-end column) and the symbols along a second column (second column from left) (see FIG. 5B) based upon the result determined in step S14. It should be noted that, in this processing, scrolling of the symbols along the first and second columns may be stopped simultaneously, or may be stopped sequentially after a predetermined interval.

Next, in step S16, the CPU 41 starts accepting the additional BET. In this processing, the CPU 41 transmits a signal (hereinafter also referred to as additional BET start signal) for making each of the stations 3 start accepting an input of the additional BET. The additional BET can be inputted at each of the stations 3 where this signal has been received. At this time, the CPU 41 starts measuring time by means of the timer 90 for measuring a second predetermined period (e.g. forty seconds).

Next, in step S17, the CPU 41 waits until the second predetermined period has passed. Upon determining that the second predetermined period has passed (step S17: YES), the CPU 41 shifts the processing to step S18.

In step S18, the CPU 41 conducts processing of ending acceptance of the additional BET. In this processing, the CPU 41 transmits a signal (hereinafter also referred to as additional BET end signal) for making each of the stations 3 end accepting an input of the additional BET. Upon receipt of this signal, each of the stations 3 ends accepting an input of the additional BET.

Next, in step S19, the CPU 41 stops scrolling the symbols along third to fifth columns (see FIG. 5C) based on the result determined in step S14. It should be noted that, in this processing, scrolling of the symbols along the third to fifth columns may be stopped simultaneously, or may be stopped sequentially after a predetermined interval.

Next, in step S20, the CPU 41 transmits to each of the stations 3 the game result, namely information about which winning line WL the same symbols have been arranged on (hereinafter also referred to as game result information). In each of the stations 3 having received the game result information, coins are paid out based upon the BET placed at each of the stations 3 and the received game result information. Paying out coins corresponds to offering a prize in the present invention. After the processing of step S20, the present subroutine is ended.

Next, the game system 1 according to the present embodiment is described.

FIG. 2 is a perspective view schematically showing an external structure of the game system according to one embodiment of the present invention.

As shown in FIG. 2, the game system 1 is comprised of the control device 20 having the main monitor 2 (see FIG. 8) and five stations 3 (stations 3a to 3e) . The station 3 corresponds to the client terminal in the present invention.

On the central portion of the main monitor 2, there is provided a front display 21, and 15 display blocks 28 in five columns and three rows are displayed thereto. One symbol is arranged in each of the display blocks 28 (see FIGS. 5A to 5C). Further, on the upper side of the main monitor 2, there is provided speakers 22 that output music and an effective sound along with the progress of a game and LEDs 23 which are lighted in a variety of renditions.

FIG. 3 is a view for illustrating the winning lines.

As shown in FIG. 3, the winning lines WL0 to WL12 are set so as to pass over any of the display blocks 28 along each column. In the present embodiment, 13 winning lines WL are set.

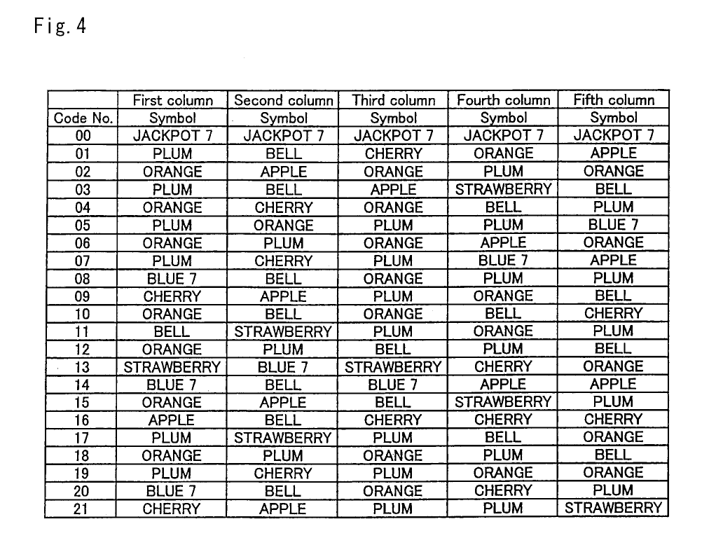

FIG. 4 is a view showing one example of symbol arrays.

As shown in FIG. 4, in each of the display blocks 28, one of a total of 22 symbols forming an array thereof is arranged or scrolled, each of the symbols having one of code numbers “00” to “21”. Each of the symbol arrays is constituted of a combination of the symbols “JACKPOT 7”, “BLUE 7”, “BELL”, “CHERRY”, “STRAWBERRY”, “PLUM”, “ORANGE”, and “APPLE”.

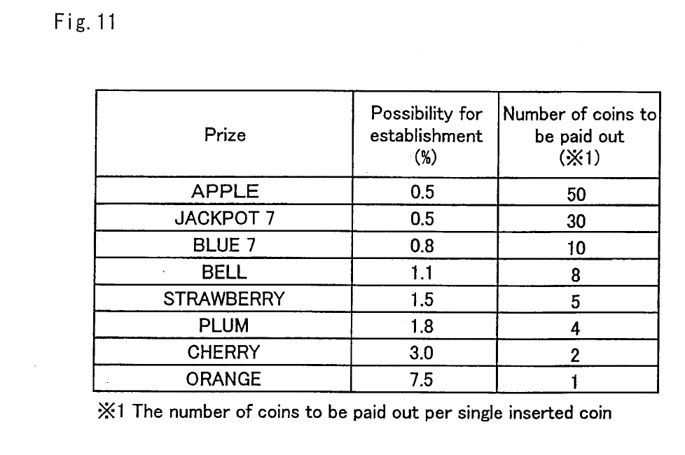

When five symbols of any one of “JACKPOT 7”, “BLUE 7”, “BELL”, “CHERRY”, “STRAWBERRY”, “PLUM”, “ORANGE”, and “APPLE” are arranged on any of the winning lines WL, the predetermined number of coins are paid out (see FIG. 11).

On predetermined timing to start scrolling of the symbols (e.g. fifteen seconds after the symbols along all the columns are stop-displayed in a previous game), all the symbols are scrolled downwardly from above. The symbols are arranged after a lapse of predetermined time. At this time, when a predetermined symbol combination is established, the player can receive a payout of the predetermined number of coins (see FIG. 11).

FIGS. 5A to 5C are views each showing one example of an image displayed to a front display provided in a main monitor.

In the game system 1, on predetermined timing after the start of accepting the normal BET, scrolling of the symbols is started as shown in FIG. 5A. The player can place the normal BET during a period from the start of accepting the normal BET until passage of the first predetermined period.

After passage of the first predetermined period, scrolling of the symbols along the first column (left-end column) and the second column (second column from left) is stopped. FIG. 5B shows one example of a state where scrolling of the symbols along the first and second columns has been stopped. “ORANGE” is arranged on the top rows of the first and second columns, and “PLUM” symbols are arranged on the middle rows of the first and second columns. Further, “ORANGE” is arranged on the bottom row of the first column while “CHERRY” is arranged on the bottom row of the second column.

Subsequently, the player can place the additional BET until passage of the second predetermined period. The player can place the additional BET considering the symbols arranged along the first and second columns.

Thereafter, as shown in FIG. 5C, scrolling of the symbols along the third to fifth columns is stopped. At this time, when the same symbols are arranged on the winning line WL on which the BET has been placed, coins corresponding to the symbol combination and the number of BETs (see FIG. 11) are paid out to the station 3 operated by the player. In FIG. 5C, “PLUM” symbols are arranged in all the display blocks 28 on the winning line WL0. Therefore, the predetermined number of coins are paid out to the station 3 of the player having placed the normal BET or the additional BET on the winning line WL0.

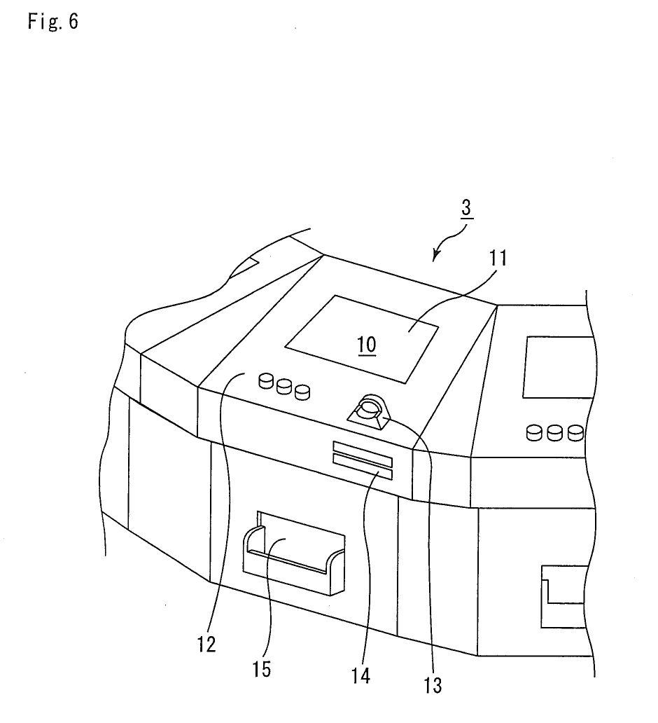

FIG. 6 is a perspective view schematically showing an external structure of the station provided in the game system shown in FIG. 2.

As shown in FIG. 6, at the center of the upper surface of the station 3, there is provided a liquid crystal display 10 for displaying later-described images regarding operations (see FIGS. 7A, 7B, 7C) and the like. Further, on the upper surface of the liquid crystal display 10, there is provided a touch panel 11 for inputting a direction such as a BET. The touch panel 11 corresponds to the BET switch in the present invention.

Operation buttons 12 for conducting a payout operation and a coin insertion slot 13 into which a coin or a medal is inserted are provided toward the front of the liquid crystal display 10.

A bill insertion slot 14 into which a bill is inserted is provided at the right end upper portion of the front of the station 3. Below the bill insertion slot 14, a coin payout exit 15 is provided for paying out coins or medals corresponding to the accumulated credits.

FIG. 7A is a view showing one example of an image displayed to the liquid crystal display when the normal BET is placed.

As shown in FIG. 7A, at the upper portion of the liquid crystal display 10, there is provided a normal Bet line select section 80 for selecting a winning line WL on which the normal BET is to be placed. In the normal BET line select section 80, BET line select buttons 81 are displayed for selecting the winning line WL on which the normal BET is to be placed. The player can operate the BET line select buttons 81 via the touch panel 11 to select the winning line WL on which the normal BET is to be placed. In FIG. 7A, the color of the BET line select button 81 corresponding to the winning line WL10 is different from the color of the other BET line select buttons 81, indicating that the BET line select button 81 corresponding to the winning line WL10 has been operated.

On the lower left side with respect to the normal BET line select section 80, there is provided a BET button display section 82. BET buttons 83 for inputting the number of BETs are displayed to the BET button display section 82. The player can operate the BET buttons 83 via the touch panel 11 to input the number of BETs on the selected winning line WL.

On the right side with respect to the BET button display section 82, there is provided a number-of-normal-BETs display section 85 for displaying the number of coins placed for the normal BET. FIG. 7A shows that a BET of 28 coins has been placed on the winning line WL10. In the case of inputting the BET of 28 coins, the player may operate the BET button 83 “10” twice, the BET button 83 “5” once and the BET button 83 “1” three times.

On the right side with respect to the number-of-normal-BETs display section 85, there is provided a number-of-credits display section 84. FIG. 7A indicates that 512 coins have been credited.

FIG. 7B is a view showing one example of an image displayed to the liquid crystal display when the additional BET is placed.

FIG. 7B is an image displayed to the liquid crystal display 10 of the station 3 having placed no normal BET. As shown in FIG. 7B, at the upper portion of the liquid crystal display 10, there is provided an additional BET line select section 86 for selecting a winning line WL on which the additional BET is to be placed. In the additional BET line select section 86, additional BET line select buttons 87 are displayed for selecting the winning line WL on which the additional BET is to be placed. The player can operate the additional BET line select buttons 87 via the touch panel 11 to select the winning line WL on which the additional BET is to be placed. The additional BET line select buttons 87 are buttons for inputting the additional BET on the winning line WL on which the normal BET has been placed at any of the stations 3 (3a to 3e) during the first predetermined period (normal BET accepting period in the current game). In the present embodiment, only the buttons, corresponding to the winning lines WL on which the normal BET has been placed at any of the stations 3 (3a to 3e) during the first predetermined period, are displayed. FIG. 7B indicates that the normal BETs have been placed on the winning lines WL1, WL2, WL10 and WL12 at any of the stations 3 (3a to 3e) during the first predetermined period, displaying that inputs of additional BETs on the winning lines WL 1, WL2, WL10 and WL12 can be accepted. Namely, in the present embodiment, a BET (additional BET) can be placed only on the winning line WL on which the normal BET has been placed.

In FIG. 7B, the color of the additional BET line select button 87 corresponding to the winning line WL12 is different from the color of the other additional BET line select buttons 87, indicating that the additional BET line select button 87 corresponding to the winning line WL12 has been operated.

On the lower left side to the additional BET line select section 86, there is provided a BET button display section 82. On the right side with respect to the BET button display section 82, there is provided a number-of-additional-BETs display section 88 for displaying the number of coins placed for the additional BET. FIG. 7B shows that a BET of 20 coins has been placed on the winning line WL12. On the right side with respect to the number-of-additional-BETs display section 88, there is provided a number-of-credits display section 84. Since the BET button display section 82 and the number-of-credits display section 84 have already been described with reference to FIG. 7A, descriptions of those are omitted here.

FIG. 7C is a view showing one example of an image displayed to the liquid crystal display when the additional BET is to be placed at the station where the normal BET has been placed.

As shown in FIG. 7C, to the lower center side of the liquid crystal display 10, the number-of-normal-BETs display section 85 and the number-of-additional-BETs display section 88 are displayed above and below. In the number-of-normal-BETs display section 85, information about the already placed normal BET is displayed. Specifically, the image of “10” indicating that the BET has been placed on the winning line WL10 and the number of BETs “28” are displayed. Since the other images have been described above with reference to FIG. 7B, descriptions of those images are omitted here.

FIG. 8 is a block diagram showing an internal structure of the control device provided in the game system shown in FIG. 2.

As shown in FIG. 8, a main control section 40 provided in the control device 20 is comprised of a microcomputer 45 as the core, which basically includes the CPU 41, a RAM 42, a ROM 43, the timer 90, and a bus 44 for transferring data mutually among these devices. The main control section 40 corresponds to the controller in the present invention.

In the ROM 43, a variety of programs for executing processing necessary in controlling the control device 20, a data table such as a payout table, and the like, are stored. The payout table is a table that defines the correspondent relationships between combinations of the symbols to be arranged on the winning lines WL and the number of coins to be paid out corresponding to respective combinations. Specific relationships between the combinations and the number of payouts are described later with reference to FIG. 11. The RAM 42 is a memory in which a variety of data computed in the CPU 41 are temporarily stored. Further, the timer 90 measures the time.

Further, the CPU 41 is connected via an I/O interface 46 to an image processing circuit 47, a sound circuit 48, a LED driving circuit 49 and a communication interface 50.

The image processing circuit 47 is connected with the front display 21 comprising the main monitor 2. The sound circuit 48 is connected with the speakers 22 comprising the main monitor 2. The LED driving circuit 49 is connected with the LEDs 23 comprising the main monitor 2. Five stations 3 are connected to the communication interface 50. The front display 21 corresponds to the display in the present invention.

The CPU 41 makes a game progress based upon a game program stored in the ROM 43 and a variety of signals received from the stations 3, displays an image to the front display 21 according to progress of the game, outputs sound from the speakers 22, and turns the LEDs 23 on. Further, the CPU 41 transmits to each of the stations 3 a variety of signals such as the normal BET start signal, the normal BET end signal, the additional BET start signal, and the additional BET end signal, according to progress of the game.

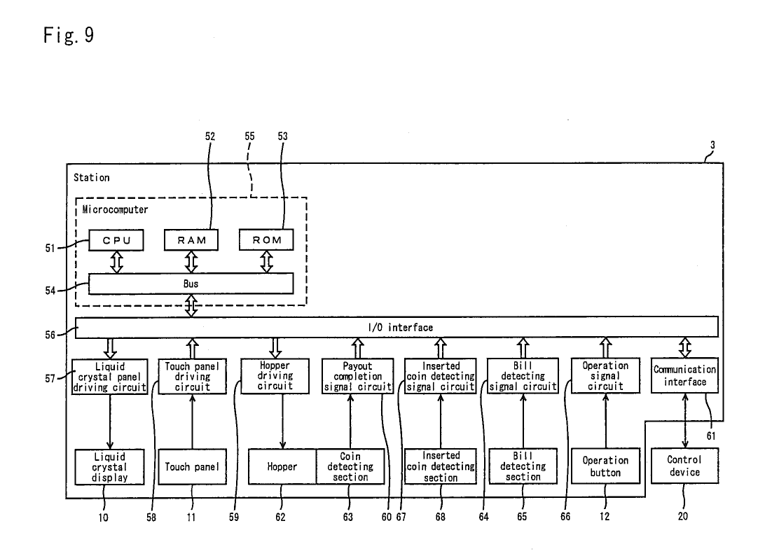

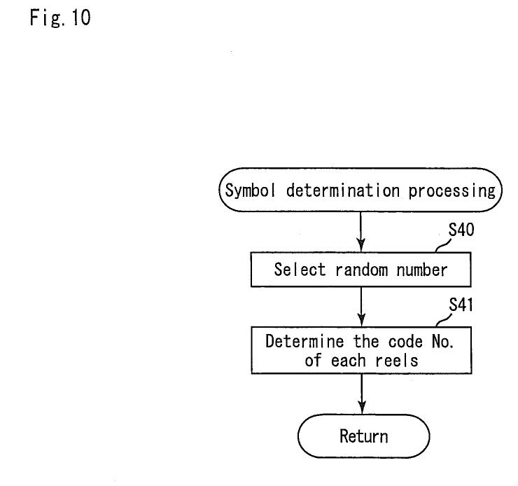

FIG. 9 is a block diagram showing an internal structure of the client terminal provided in the game system shown in FIG. 2.

As shown in FIG. 9, the station 3 is comprised of a microcomputer 55 as a core, which basically includes a CPU 51, a RAM 52, a ROM 53, and a bus 54 for transferring data mutually among these devices. The main control section 40 corresponds to the controller in the present invention.

In the ROM 53, a variety of programs, a data table and the like for executing processing necessary in controlling the stations 3 are stored. Further, the RAM 52 temporarily stores the number of credits currently accumulated in the stations 3 and a variety of data computed in the CPU 51.

Moreover, the CPU 51 is connected via an I/O interface 56 to a liquid crystal panel driving circuit 57, a touch panel driving circuit 58, a hopper driving circuit 59, a payout completion signal circuit 60, an inserted coin detecting signal circuit 67, a bill detecting signal circuit 64, an operation signal circuit 66, the camera 16, and a communication interface 61.

The liquid crystal display 10 is connected to the liquid crystal panel driving circuit 57. The touch panel 11 is connected to the touch panel driving circuit 58. A hopper 62 is connected to the hopper driving circuit 59. A coin detecting section 63 is connected to the payout completion signal circuit 60. An inserted coin detecting section 68 is connected to the inserted coin detecting signal circuit 67. A bill detecting section 65 is connected to the bill detecting signal circuit 64. The operation buttons 12 are connected to the operation signal circuit 66.

The hopper 62 is provided inside the station 3, and pays out coins from the coin payout exit 15 based upon a control signal outputted from the CPU 51.

The coin detecting section 63 is provided inside the coin payout exit 15, and transmits a signal to the CPU 51 upon detecting that a predetermined number of coins have been paid out from the coin payout exit 15.

The inserted coin detecting section 68 detects the amount of coins upon detection of the coins inserted from the coin insertion slot 13, and transmits a detecting signal indicating the detected amount to the CPU 51. The detected coins counted regarding a predetermined amount as one credit are stored into the RAM 52.

The bill detecting section 65 detects an amount of bills when the bills are accepted, and transmits a detecting signal indicating the detected amount to the CPU 51. The detected bills counted regarding a predetermined amount as one credit are stored into the RAM 52.

The operation buttons 12 are buttons for conducting a payout operation when a payout of coins is determined.

Next, processing executed in the control device 20 and the stations 3 are described. However, since the processing concerning the control device 20 has already been described by using FIG. 1, only the symbol determination processing, which is called and executed in step S14 shown in FIG. 1, is described.

First, the main CPU 41 executes a program for random number generation included in a game program, to select a random number corresponding to each of the symbol columns, out of the numbers falling in a numerical range of 0 to 255 (step S40). In the present embodiment, a case of generating a random number on a program (a case of using a so-called software random number) is described. However, in the present invention, a random number generator may be provided and the random number may then be extracted from the random number generator (a so-called hardware random number may be used).

Next, the main CPU 41 determines the code Nos. of the respective symbol columns (see FIG. 4) based upon five selected random numbers (step S41). The respective code Nos. of each of the symbol columns correspond to the respective code Nos. of stop-displayed symbols on the winning line WL0 on each of the columns. The main CPU 41 determines the code No. of each symbol column to determine a symbol combination. For example, when the CPU 41 determines the code Nos. of the respective symbol columns as “00”, “00”, “00”, “00”, “00”, this means that the main CPU 41 determines “JACKPOT 7” as the symbol combination.

Here, the symbol combination in the present embodiment is described.

FIG. 11 is a view showing possibilities for establishment of the symbol combinations and the number of payouts.

When five “APPLE” symbols are arranged on a winning line WL, 50 coins are paid out per inserted coin. Further, when five “JACKPOT 7” symbols are arranged on a winning line WL, 30 coins are paid out per inserted coin. Similarly, when five of any one of the symbols “BLUE 7”, “BELL”, “STRAWBERRY”, “PLUM”, “CHERRY”, and “ORANGE” are arranged on a winning line WL, the number of coins corresponding to each of the combinations is paid out.

Next, the processing to be executed in the station 3 is described.

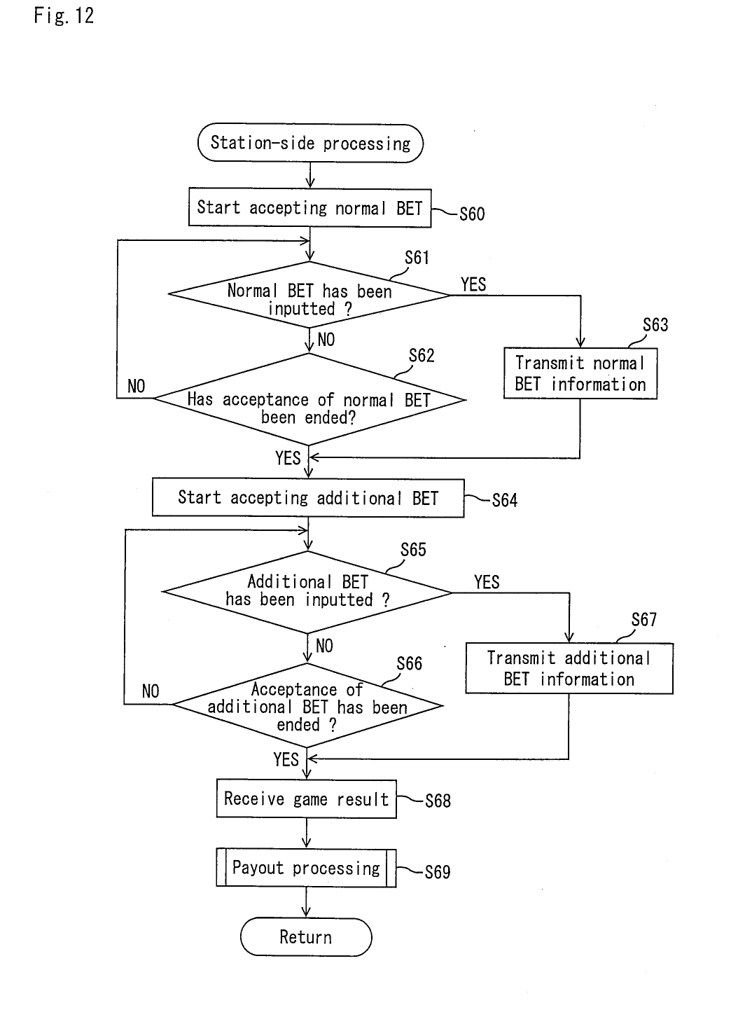

FIG. 12 is a flowchart showing a subroutine of a station-side processing executed in the station.

First, in step S60, when the CPU 51 provided in the station 3 receives a normal BET start signal from the control device 20, the CPU 51 starts accepting the normal BET. At this time, the CPU 51 displays the image shown in FIG. 7A to the liquid crystal display 10.

Next, in step S61, the CPU 51 determines whether or not the normal BET has been inputted via the touch panel 11. In this processing, the CPU 51 determines whether or not the BET line select button 81 and the BET buttons 83 (see FIG. 7A) have been operated via the touch panel 11.

Upon determining that no normal BET has been inputted (step S61: NO), the CPU 51 determines whether or not to end accepting the normal BET (step S62) . In this processing, upon receiving a normal BET end signal from the control device 20, the CPU 51 determines to end accepting the normal BET. An input of the normal BET is considered to be accepted when the normal BET is inputted during a period from the start of accepting the normal BET in step S60 until the end of accepting the normal BET in step S62.

When determining not to end accepting the normal BET, the CPU 51 returns the processing to step S61. On the other hand, when determining to end accepting the normal BET, the CPU 51 shifts the processing to step S64.

In step S61, when determining that the normal BET has been inputted, the CPU 51 transmits normal BET information showing that the normal BET has been placed and contents of the normal BET, to the control device 20 (step S63). The contents of the normal BET include the number of the winning line WL to which the normal BET is subject to and the number of BETs. After the processing of step S63, the processing is shifts to step S64.

Next, in step S64, upon receipt of an additional BET start signal from the control device 20, the CPU 51 starts accepting the additional BET. At this time, the CPU 51 displays the image shown in FIG. 7B or 7C to the liquid crystal display 10.

Next, in step S65, the CPU 51 determines whether or not the additional BET has been inputted via the touch panel 11. In this processing, the CPU 51 determines whether or not the additional BET line select buttons 87 and the BET buttons 83 (see FIGS. 7B, 7C) have been operated via the touch panel 11.

Upon determining that no additional BET has been inputted (step S65: NO), the CPU 51 determines whether or not to end accepting the additional BET (step S66) . In this processing, upon receipt of an additional BET end signal from the control device 20, the CPU 51 determines to end accepting the additional BET. An input of the additional BET is considered to be accepted when the additional BET is inputted during a period from the start of accepting the additional BET in step S64 until the end of accepting the additional BET in step S66.

When determining not to end accepting the additional BET, the CPU 51 returns the processing to step S65. On the other hand, when determining to end accepting the additional BET, the CPU 51 shifts the processing to step S68.

In step S65, upon determining that the additional BET has been inputted, the CPU 51 transmits information that the additional BET has been placed and additional BET information showing contents of the additional BET to the control device 20 (step S67). The contents of the additional BET includes the number of the winning line WL on which the additional BET is placed and the number of BETs. After the processing of step S67, the processing shifts to step S68.

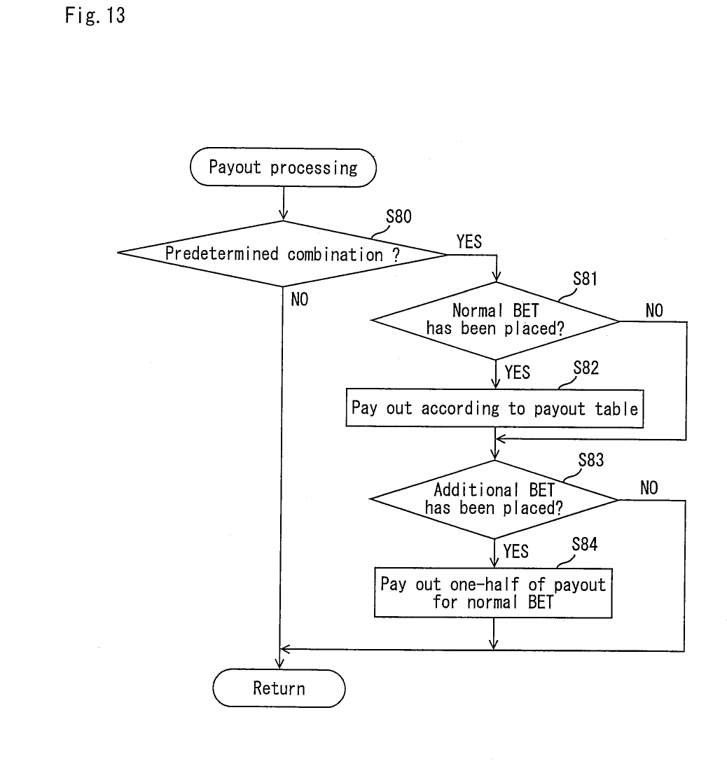

In step S68, the CPU 51 receives game result information from the control device 20. Next, in step S69, the CPU 51 conducts payout processing based upon the received game result information, to end the present subroutine. The payout processing will be described in details with reference to FIG. 13.

FIG. 13 is a flowchart showing a subroutine of payout processing.

First, the CPU 51 determines whether or not any of the predetermined symbol combinations has been established on the winning line WL on which the normal BET or the additional BET has been placed. When determining that any of the predetermined symbol combinations has been established, the CPU 51 shifts the processing to step S81. On the other hand, when determining that no predetermined symbol combination has been established, the CPU 51 ends the present subroutine.

In step S81, the CPU 51 determines whether or not the normal BET has been placed. Upon determining that the normal BET has been placed, the CPU 51 pays out the number of coins according to the payout table (step S82). For example, when the combination constituted of “APPLE” is established, 50 coins are paid out (see FIG. 11).

In step S81, upon determining that no normal BET has been placed, or after executing the processing of step S82, the CPU 51 determines whether or not the additional BET has been placed (step S83) . Upon determining that the additional BET has been placed, the CPU 51 pays out one-half of the number of coins to be paid out at the time of the normal BET (step S84) . For example, when the combination constituted of “APPLE” is established, 25 coins are paid out (FIG. 11). In addition, when a fraction occurs, it may be rounded up or rounded down.

In step S83, upon determining that no additional BET has been placed, or after executing the processing of step S84, the CPU 51 ends the present subroutine.

As described above, the game system 1 according to the present embodiment includes the plurality of stations 3 having the touch panel 11 (BET switch) for inputting a BET. Further, the game system 1 includes the liquid crystal display 10 (display) viewable by a player who executes a game in each of the stations 3. Moreover, the game system 1 includes the main control section 40 (controller) programmed so as to execute the following processing of: (a) executing a slot machine game to display a result to the front display 21 (display) ; (b) accepting an input of a normal BET via each of the touch panels 11 provided in the plurality of stations 3 during the first predetermined period until the slot machine game result is displayed to the front display 21; (c) accepting an input of an additional BET to add an BET to any of the normal BETs inputted within the first predetermined period, via the respective touch panels 11 in any of the plurality of station 3 at which no normal BET has been inputted, during a second predetermined period until the game result is displayed to the front display 21 after passage of the first predetermined period; (d) offering a prize corresponding to the slot machine game result and the inputted normal BET, to any of the plurality of stations 3 at which the normal BET has been inputted; and (e) conducting a payout corresponding to the slot machine game result and the inputted additional BET, to any of the plurality of stations 3 at which the additional BET has been inputted.

Although the case where an input of the additional BET is also accepted from the station 3 at which the normal BET has been inputted has been described in the present embodiment, the present invention is not limited to this example, and an input of a middle-of-game BET (additional BET) may not be accepted from the client terminal at which the normal BET has been inputted.

Although the case where the first predetermined period is a period from the start of accepting the normal BET until stop of scrolling the symbols along the first and second columns has been described in the present embodiment, the first predetermined period in the present invention is not particularly limited so long as being a period until the start of the second predetermined period.

Although the case where the second predetermined period is a period from stop of scrolling the symbols along the first and second columns until stop of scrolling the symbols along the third to fifth columns has been described in the present embodiment, the second predetermined period in the present invention is not particularly limited so long as being within a period after the first predetermined period passes and until the state of allowing the player to recognize the game result.

Further, in the present invention, a plurality of second predetermined periods may be set. In this case, for example, a prize may be offered corresponding to the middle-of-game BET placed in each of the second predetermined periods, e.g. a payout for a middle-of-game BET placed in one second predetermined period may be made larger than a payout for a middle-of-game BET placed in a subsequent second predetermined period.

In the present embodiment, the case has been described where it is allowed to place a BET on any of normal BETs having inputted at the other stations 3 and coins corresponding to the game result (arrangement state of the symbols) and the inputted normal BET are paid out to any of the stations 3 at which the normal BET has been inputted, while coins (one-half of the number of coins at the time of the normal BET) corresponding to the game result and the inputted additional BET are paid out to any of the stations 3 at which the middle-of-game BET has been inputted.

However, the present invention is not limited to this example. It may be allowed to place a BET (additional BET) subject to the client terminals at which the normal BET has been inputted and a prize is offered to the client terminal at which the normal BET has been inputted, the prize corresponding to the game result (e.g. arrangement state of the symbols) with respect to the normal BET and the inputted normal BET, while a prize may be offered to the client terminal at which an additional BET has been inputted, the prize corresponding to the game result (e.g. the total number of coins acquired in the client terminal at which the normal BET has been inputted) in the client terminal at which the normal BET has been inputted and the inputted additional BET.

In the present invention, the “additional BET subject to the client terminals at which the normal BET has been inputted” means a BET subject to contents of the normal BET inputted at the client terminal where the normal BET has been inputted. Examples of such a BET may include a BET placed on selection of a wining line when the winning line is selected and a BET is placed on that winning line at the client terminal at which the normal BET has been inputted.

In the present invention, the “game result with respect to the normal BET” means a game result to be referred to when a prize is offered to the client terminal at which the normal BET is placed.

Further, the “game result in the client terminal at which the normal BET has been inputted” means a result determined according to the game result and the normal BET in the client terminal at which the normal BET has been inputted.

Although in the present embodiment, the case has been described where the middle-of-game BET in the first aspect of the present invention is the additional BET, namely the case where the normal BET and the middle-of-game BET are placed on the same subject (winning line WL) while different numbers of payouts are conducted to those BETs, the first aspect of the present invention is not limited to this example so long as the subject on which a BET is placed or the number of payouts is different between the normal BET and the middle-of-game BET.

Examples of the different subjects between the normal BET and the middle-of-game BET may include a case where, when the normal BET is a BET on a winning line in a roulette game, the middle-of-game BET is placed on which player out of players playing the game will acquire the largest number of coins. In this case, coins are paid out to the client terminal at which the middle-of-game BET has been inputted, according to a game result (the number of coins acquired in the client terminal at which the normal BET is inputted) in each of the client terminals, and the inputted middle-of-game BET.

Additionally, other examples where the subjects for the normal BET and the middle-of-game BET are different may include a case where, when the normal BET is a BET on a winning line in a roulette game, the middle-of-game BET is a BET on which symbol will be displayed most to the display. In this case, coins are paid out to the client terminal at which the middle-of-game BET has been inputted, according to a game result (arrangement pattern of the symbols) and the inputted middle-of-game BET.

Although the case of playing the slot machine game has been described in the present embodiment, the game to be executed in the present invention is not limited to this example, as long as a game which can be joined by a plurality of players and in which a BET is placed on a predetermined subject, e.g. a roulette game, a bingo game, and card games such as poker, Black Jack and a tarot card game.

Although the case of including a plurality of stations 3 has been described in the present embodiment, a station (client terminal) may not be provided in the present invention so long as it is possible to accept an input of a middle-of-game BET, which is different from a normal BET inputted within the first predetermined period, during a second predetermined period after passage of the first predetermined period.

Although the case of playing a game in the game system 1 has been described in the present embodiment, a game may be played by a plurality of players without the use of the game system 1 in the present invention (e.g. roulette game in which a game is progressed by a dealer). In this case, a method for playing a game that includes the following steps (a) to (e) can be adopted: (a) accepting a normal BET during a first predetermined period; (b) accepting a middle-of-game BET, which is different from the normal BET placed within the first predetermined period, from a player having placed no normal BET, during a second predetermined period after passage of the first predetermined period; (c) executing the game to determine a result; (d) offering a prize corresponding to the game result and the normal BET, to a player having placed the normal BET; and (e) offering a prize corresponding to the game result and the middle-of-game BET, to the player having placed the middle-of-game BET.

Although the embodiment according to the present invention has been described above, the description presents only some of the specific examples, and does not particularly limit the present invention, and specific constitutions of each means and the like can be properly changed in terms of design. Further, the effects described in the embodiment of the present invention are only examples of the most preferable effects generated from the present invention and the effect to be caused by the present invention is not limited to those described in the embodiment of the present invention.

In the above detailed description, for a better and easier understanding of the present invention, the description is mainly made on the featuring aspects of the present invention. The present invention is not limited to the embodiments in the above detailed description, and may be applied to other varieties of embodiments. Also, it is to be understood that the phraseology and terminology employed in this specification are used to precisely describe the present invention, and should not be regarded as limiting the interpretation of the present invention. Moreover, based on the conception described in the present specification, those skilled in the art will readily come up with other configuration, systems and methods and the like included in the conception of the present invention. As such, it should be elucidated that the claims include such equivalent constitutions insofar as they do not depart from the spirit and scope of the present invention. Further, the purpose of the foregoing abstract is to enable the U.S. Patent and Trademark Office and general public institutions, and those skilled in the art and the like who are not familiar with patent or legal terminology, to quickly determine the nature and essence of the technical disclosure of this application with a simple search. Therefore, the abstract is not intended to define the scope of the present invention, which should be measured by the description of the claims. Furthermore, for fully understanding the purposes and the featuring effects of the present invention, desirably, the present invention is interpreted with reference to published publications and the like.

The detailed descriptions aforementioned may be presented in terms of processing executed by a computer. Those descriptions and terms set forth in the above are described for the purpose that those skilled in the art understand the present invention in a most effective way. In the present specification, each step used for leading one result should be understood a self-consistent procedure. In each step, sending and receiving, or recording or the like of electrical or magnetic signals are performed. Although, such signals are expressed in bit, value, symbol, character, term, number and the like in processing of each step; however, it is important to note that those expressions are used simply for convenience of explanation. Moreover, processing in each step is in some cases described using expressions in common with those for human activities, but processing described in the present specification is in principle performed by various apparatuses. Furthermore, some other constitutions required for carrying out the respective step are considered to be self-explanatory from the aforementioned descriptions.

What is claimed as new and desired to be secured by letters patent of the united states is:

1. A game system comprising:
a plurality of client terminals, each of which having a BET switch for inputting a BET; and
a controller,
said controller programmed so as to execute the following processing of:
(a) accepting an input of a normal BET from each of said BET switches provided in said plurality of client terminals during a first predetermined period;
(b) accepting an input of a middle-of-game BET, which is different from the normal BET inputted within said first predetermined period, from said respective BET switches in any of said plurality of client terminals at which no normal BET has been inputted, during a second predetermined period after passage of said first predetermined period;
(c) executing a game to determine a result;
(d) offering a prize corresponding to the game result and the inputted normal BET, to any of said plurality of client terminals at which the normal BET has been inputted; and
(e) offering a prize corresponding to the game result and/or the game result in any of said plurality of client terminals at which the normal BET has been inputted and the inputted middle-of-game BET, to any of said plurality of client terminals at which the middle-of-game BET has been inputted.

2. A game system comprising:
a plurality of client terminals, each of which having a BET switch for inputting a BET; and
a controller,
said controller programmed so as to execute the following processing of:
(a) accepting an input of a normal BET from each of said BET switches provided in said plurality of client terminals during a first predetermined period;
(b) accepting an input of an additional BET subject to any of said plurality of client terminals at which the normal BET has been inputted within said first predetermined period, from said respective BET switches in any of said plurality of client terminals at which no normal BET has been inputted, during a second predetermined period after passage of said first predetermined period;
(c) executing a game to determine a result;
(d) offering a prize corresponding to the game result with respect to the normal BET and the inputted normal BET, to any of said plurality of client terminals at which the normal BET has been inputted; and
(e) offering a prize corresponding to the game result in any of said plurality of client terminals at which the normal BET has been inputted and the inputted additional BET, to any of said plurality of client terminals at which the additional BET has been inputted.

3. A game system comprising:
a plurality of client terminals, each of which having a BET switch for inputting a BET;
a display viewable by a player who executes a game at each of said plurality of client terminals; and
a controller,
said controller programmed so as to execute the following processing of:
(a) executing a game to display a result to said display;
(b) accepting an input of a normal BET from each of said BET switches provided in said plurality of client terminals during a first predetermined period until the game result is displayed to said display;
(c) accepting an input of an additional BET subject to any of said plurality of client terminals at which the normal BET has been inputted within said first predetermined period, from said respective BET switches in any of said plurality of client terminals at which no normal BET has been inputted, during a second predetermined period until the game result is displayed to said display after passage of said first predetermined period;
(d) offering a prize corresponding to the game result with respect to the normal BET and the inputted normal BET, to any of said plurality of client terminals at which the normal BET has been inputted; and
(e) offering a prize corresponding to the game result in any of said plurality of client terminals at which the normal BET has been inputted and the inputted additional BET, to any of said plurality of client terminals at which the additional BET has been inputted.

4. A game system comprising:
a plurality of client terminals, each of which having a BET switch for inputting a BET; and
a controller, said controller programmed so as to execute the following processing of:
(a) accepting an input of a normal BET from each of said BET switches provided in a plurality of said client terminals during a first predetermined period;
(b) accepting an input of a middle-of-game BET, which is different from the normal BET inputted within said first predetermined period, from said respective BET switches in any of said plurality of client terminals at which no normal BET has been inputted, during a second predetermined period of a game progress after passage of said first predetermined period;
(c) executing a game to determine a result;
(d) offering a prize corresponding to the game result and the inputted normal BET, to any of said plurality of client terminals at which the normal BET has been inputted; and
(e) offering a prize corresponding to the game result and/or the game result in any of said plurality of client terminals at which the normal BET has been inputted and the inputted middle-of-game BET, to any of said plurality of client terminals at which the middle-of-game BET has been inputted.

5. A playing method of a game comprising the steps of:
(a) accepting a normal BET during a first predetermined period;
(b) accepting a middle-of-game BET, which is different from the normal BET placed within said first predetermined period, from a player having placed no normal BET, during a second predetermined period after passage of said first predetermined period;
(c) executing a game to determine a result;
(d) offering a prize corresponding to the game result and the normal BET, to a player having placed the normal BET; and
(e) offering a prize corresponding to the game result and/or the game result of the player having placed the normal BET and the middle-of-game BET, to the player having placed the middle-of-game BET.
